(19) United States
(12) Patent Application Publication
(10) Pub. No.: US 2014/0030683 A1
(43) Pub. Date: Jan. 30, 2014

(54) SENSORY INPUT DEVICES, AND SENSORY INPUT METHODS

(71) Applicant: Rebecca Anna BALLARD, Cicero, NY (US)

(72) Inventor: Rebecca Anna BALLARD, Cicero, NY (US)

(21) Appl. No.: 13/949,438

(22) Filed: Jul. 24, 2013

Related U.S. Application Data
(60) Provisional application No. 61/674,983, filed on Jul. 24, 2012.

(51) Int. Cl. G09B 25/00

(52) U.S. Cl. CPC G09B 25/00
USPC 434/236

(57) ABSTRACT

A sensory input device comprising at least one contact structure, at least one image of a hand on a first surface of the contact structure, at least one image of a foot on a second surface of the contact structure, at least one representation of a hand perceptible on the first surface, and/or at least one representation of a foot perceptible on the second surface. A sensory input apparatus comprising a sensory input device attached to at least one support structure. A method comprising positioning a person a person who has been characterized as having compromised sensory functions on a swing that can swing to a location where the person's hands or feet can contact a sensory input device.

### CROSS-REFERENCE TO RELATED APPLICATIONS

This application claims the benefit of U.S. Provisional Patent Application No. 61/674,983, filed Jul. 24, 2012, the entirety of which is incorporated herein by reference as if set forth in its entirety.

### FIELD OF THE INVENTIVE SUBJECT MATTER

The present inventive subject matter is directed to sensory input methods, and to devices that can be used in connection with providing or enhancing sensory input.

### BACKGROUND

It has been well documented that certain sensory inputs can have calming effects for persons in need of (or desiring) such effects, e.g., patients with autistic disorder. For example, it has been reported that deep touch pressure (e.g., surface pressure that is exerted in most types of firm touching, holding, stroking, petting of animals, or swaddling) has been found to have beneficial effects in a variety of clinical settings (e.g., see Grandin, “Calming Effects of Deep Touch Pressure in Patients with Autistic Disorder, College Students, and Animals” (1992). Machines that provide deep touch pressure have been proposed (e.g., the “squeeze machine” described in Grandin, “Calming Effects of Deep Touch Pressure in Patients with Autistic Disorder, College Students, and Animals” (1992).

### BRIEF SUMMARY

In accordance with the present inventive subject matter, there is provided a device that is uncomplicated and easy to use, but that can provide very beneficial results for some people.

In one aspect of the present inventive subject matter, there is provided a sensory input device that comprises at least one contact structure that comprises a first surface and a second surface, with at least one representation of a hand perceptible on the first surface, and at least one representation of a foot perceptible on the second surface. Devices in accordance with this aspect of the present inventive subject matter can he used in any of a variety of ways.

One representative example of a way that a device in accordance with the present inventive subject matter can he used is for a person (e.g., a person with autism) to swing on a swing in a sitting position and kick with his or her foot (or feet) to impact (e.g., with a jarring sensation) on the representation of the foot (or feet) on the second surface of the contact structure during the swinging motion (e.g., at or near the highest position during the forward part of the swing motion (or at any other suitable point in the range of positions while swinging)). The expression “forward part of the swing motion” means the half (or approximately half) of the swinging motion cycle during which the person on the swing is moving in a forward direction (as opposed to the “backward part of the swing motion”, i.e., the half (or approximately half) of the swinging motion cycle during which the person on the swing is moving in a backward direction.

Another representative example of a way that a device in accordance with the present inventive subject matter can be used is for a person (e.g., a person with autism) to swing on a swing in a prone position (i.e., with the person lying with his or her stomach on the swing) and contact the contact structure with his or her hand (or hands) to impact (e.g., with a jarring sensation) on the representation of the hand (or hands) on the first surface of the contact structure during the swinging motion (e.g., during the forward part of the swing motion as the swing is moving upward, or during the first part of the backward part of the swing motion).

In accordance with a first aspect of the present inventive subject matter, there is provided a sensory input device comprising:

at least one contact structure that comprises a first surface and a second surface,
the first surface and the second surface being major surfaces of the contact structure,

an image of a left hand back side and an image of a right hand back side on the first surface,

an image of a left foot top side and an image of a right foot top side on the second surface,
the image of a left hand back side to the left of the image of a right hand back side,
the image of a left hand hack side being substantially the same size as the image of a right hand back side,
the image of a left foot top side to the left of the image of a right foot top side,
the image of a left foot top side being substantially the same size as the image of a right foot top side,
the orientation of the image of a left hand back side being substantially the same as the orientation of the image of a right hand back side,
the orientation of the image of a right foot top side being substantially the same as the orientation of the image of a left foot top side.

In some embodiments in accordance with the first aspect of the present inventive subject matter, the first surface and the second surface each have a first axis of substantial symmetry and a second axis of substantial symmetry, the first axis of substantial symmetry is longer than the second axis of substantial symmetry, the second axis of substantial symmetry is oriented in a first direction, and the orientation of the image of a left hand back side and the orientation of the image of a right hand back side are aligned with the first direction.

In accordance with a second aspect of the present inventive subject matter, there is provided a sensory input device comprising:

at least one contact structure that comprises a first surface and a second surface,
at least one representation of a hand perceptible on the first surface,
at least one representation of a foot perceptible on the second surface.

In some embodiments in accordance with the second aspect of the present inventive subject matter:
an image of a left hand back side and an image of a right hand back side are on the first surface,
the image of a left hand back side is to the left of the image of a right hand back side,
the orientation of the image of a left hand back side is substantially the same as the orientation of the image of a right hand back side and is aligned with a first dimension of the sensory input device,
the orientation of the image of a right foot top side is substantially the same as the orientation of the image of a left foot top side and is aligned with the first dimension.

In some embodiments in accordance with the second aspect of the present inventive subject matter:
a representation of a left hand back side and a representation of a right hand back side are on the first surface,
the representation of a left hand back side is to the left of the representation of a right hand back side,
the representation of a left hand back side is substantially the same size as the representation of a right hand back side,
a representation of a left foot top side and a representation of a right foot top side are on the second surface,
the representation of a left foot top side is to the left of the representation of a right foot top side,
the representation of a left foot top side is substantially the same size as the representation of a right foot top side.

In some embodiments in accordance with the second aspect of the present inventive subject matter, one or more of the representations are images, and/or one or more of the representations are structural.

In some embodiments in accordance with the second aspect of the present inventive subject matter, one or more of the representations are images and structural (e.g., structural with images thereon.

In some embodiments in accordance with the second aspect of the present inventive subject matter, the first surface and the second surface are major surfaces of the contact structure.

In accordance with a third aspect of the present inventive subject matter, there is provided a sensory input device comprising:

at least one contact structure that comprises a first surface and a second surface,
the first surface and the second surface being major surfaces of the contact structure,
the first surface and the second surface each having a first axis of substantial symmetry and a second axis of substantial symmetry, the first axis of substantial symmetry being longer than the second axis of substantial symmetry, the second axis of substantial symmetry being oriented in a first direction,

an image of a left hand back side and an image of a right hand back side on the first surface,
the image of a left hand back side to the left of the image of a right hand back side,
the image of a left hand back side being substantially the same size as the image of a right hand back side,
the orientation of the image of a left hand back side being substantially the same as the orientation of the image of a right hand back side,
the orientation of the image of a left hand back side and the orientation of the image of a right hand back side being aligned with the first direction.

In accordance with a fourth aspect of the present inventive subject matter, there is provided a sensory input device comprising:

at least one contact structure that comprises a first surface and a second surface,
the first surface and the second surface being major surfaces of the contact structure,
the first surface and the second surface each having a first axis of substantial symmetry and a second axis of substantial symmetry, the first axis of substantial symmetry being longer than the second axis of substantial symmetry, the second axis of substantial symmetry being oriented in a first direction,

an image of a left foot top side and an image of a right foot top side on the first surface,
the image of a left foot top side to the left of the image of a right foot top side,
the image of a left foot top side being substantially the same size as the image of a right foot top side,
the orientation of the image of a left foot top side being substantially the same as the orientation of the image of a right foot top side,
the orientation of the image of a left foot top side and the orientation of the image of a right foot top side being aligned with the first direction.

In some embodiments in accordance with the first aspect or the second aspect of the present inventive subject matter:
the first surface and the second surface are each generally rectangular,
the first surface and the second surface each have a first dimension in the range of from about six inches to about fourteen inches (in some cases, from about eight inches to about twelve inches) and a second dimension in the range of from about eighteen inches to about four feet (in some cases, from about twenty-two inches to about three feet), and
the first surface and the second surface are substantially parallel and spaced from each other by from about one inch to about two inches.

In some embodiments in accordance with the third aspect or the fourth aspect of the present inventive subject matter:
the contact structure has a dimension along the first axis of substantial symmetry that is in the range of from about eighteen inches to about four feet, and
the contact structure has a dimension along the second axis of substantial symmetry that is in the range of from about six inches to about fourteen inches.

In some embodiments in accordance with the present inventive subject matter, the sensory input device comprises at least one handle.

In some embodiments in accordance with the present inventive subject matter:
the sensory input device comprises a first handle and a second handle,
the first handle comprises a first hole extending from the first surface to the second surface, and
the second handle comprises a second hole extending from the first surface to the second surface.

In other aspects of the present inventive subject matter, there is provided a sensory input apparatus comprising:
a sensory input device corresponding to any of the subject matter described above; and
at least one support structure, the sensory input device being attached to the support structure.

In accordance with a fifth aspect of the present inventive subject matter, there is provided a method comprising positioning a person who has been characterized as having compromised sensory functions (e.g., based on a score in a SIPT (Sensory Integration and Praxis Test)(for example a score of less than 85) and/or based on a Sensory Performance Assessment) on a swing that can swing to a location where the person's hands or feet can contact a sensory input device corresponding to any of the subject matter described above.

The inventive subject matter may be more fully understood with reference to the accompanying drawings and the following detailed description of the inventive subject matter.

### BRIEF DESCRIPTION OF THE DRAWING FIGURES

FIGS. 1 and 2 are perspective views of an embodiment of a sensory input device 10.

FIGS. 3 and 4 are perspective views of an embodiment of a sensory input device 30.

FIG. 5 illustrates an embodiment of a sensory input apparatus 50.

FIG. 6 illustrates an embodiment of a sensory input apparatus 60.

### DETAILED DESCRIPTION

When an element such as a layer, region or substrate is referred to herein as being “on”, being mounted “on”, being mounted “to”, or extending “onto” another element, it can be in or on the other element, and/or it can be directly on the other element, and/or it can extend directly onto the other element, and it can be in direct contact or indirect contact with the other element (e.g., intervening elements may also be present). In contrast, when an element is referred to herein as being “directly on” or extending “directly onto” another element, there are no intervening elements present. Also, when an element is referred to herein as being “connected” or “coupled” to another element, it can be directly connected or coupled to the other element, or intervening elements may be present. In contrast, when an element is referred to herein as being “directly connected” or “directly coupled” to another element, there are no intervening elements present. In addition, a statement that a first element is “on” a second element is synonymous with a statement that the second element is “on” the first element.

The expression “in contact with”, as used herein, means that the first structure that is in contact with a second structure is in direct contact with the second structure or is in indirect contact with the second structure. The expression “in indirect contact with” means that the first structure is not in direct contact with the second structure, but that there are a plurality of structures (including the first and second structures), and each of the plurality of structures is in direct contact with at least one other of the plurality of structures (e.g., the first and second structures are in a stack and are separated by one or more intervening layers). The expression “direct contact”, as used in the present specification, means that the first structure which is “in direct contact” with a second structure is touching the second structure and there are no intervening structures between the first and second structures at least at some location.

Although the terms “first”, “second”, etc. may be used herein to describe various elements, components, structures, regions, surfaces, sides, directions, dimensions, axes, etc., these elements, components, structures, regions, surfaces, sides, directions, dimensions, axes, etc., should not be limited by these terms. These terms are only used to distinguish one elements, components, structures, regions, surfaces, sides, directions, dimensions, axes, etc., from another or others. Thus, a first elements, components, structures, regions, surfaces, sides, directions, dimensions, axes, etc., discussed below could be tensed a second elements, components, structures, regions, surfaces, sides, directions, dimensions, axes, etc., without departing from the teachings of the present inventive subject matter.

Relative terms, such as“bottom”,“top”, “horizontally” or “vertical” may be used herein to describe one element's relationship to another clement (or to other elements). For example, if a device is inverted, elements described as being on the “bottom” would no longer be on the bottom, and might be on the “top.”

The expression “representation”, as used herein, e.g. in the expression “representation of a left hand back side”, means an image that can be perceived by human vision or a structure that can be felt by the human sense of touch.

In some embodiments in accordance with the present inventive subject matter, the expression “representation of a left hand back side”, as used herein, e.g. in the expression “a representation of a left hand back side and a representation of a right hand back side are on the first surface” means that an image or a structure corresponding to a back side of a left hand is on the first surface (i.e., if the representation of the hand is oriented such that at least a representation of one finger is pointing upward, a representation of a thumb would be on the right side of the representation of the hand). In some embodiments in accordance with the present inventive subject matter, the expression “representation of a left hand back side” encompasses any representation that would be interpreted as representing a left hand (with the back side of the hand facing the viewer) by at least 50 percent of a randomly selected group of people (the group including at least ten people)—for instance, at least 50 percent of a randomly selected group of people, upon being shown the representation(s) and asked to give one answer as to what the representation(s) is (are), would give “a hand” (or “hands”) as their response.

In some embodiments in accordance with the present inventive subject matter, the expression “representation of a left hand back side”, as used herein, e.g. in the expression “a representation of a left hand back side and a representation of a right hand back side are on the first surface” means that an image or a structure corresponding to a back side of a left hand is on the first surface (i.e., if the representation of at least one of the fingers is pointing upward, the representation of a thumb would be to the right of the representations of the fingers). In some embodiments in accordance with the present inventive subject matter, the expression “corresponding to a back side of a left hand” (e.g., as used in the preceding sentence) encompasses any structure that has (1) a back-of-hand region, (2) four finger regions extending from a first side of the back-of-hand region, each finger extending from the back-of-hand region in a direction that is within 45 degrees from a first direction, and (3) a thumb region extending from a second side of the back-of-hand region at an angle in the range of from 0 to 90 degrees from the first direction.

In some embodiments in accordance with the present inventive subject matter, the expression “corresponding to a back side of a left hand”, encompasses only representations that have (1) a back-of-hand region, (2) four finger regions extending from the back-of-hand region, and (3) a thumb region extending from the back-of-hand region, where at least 70 percent (and in some embodiments, at least 80 percent, at least 85 percent or at least 90 percent) of the surface area of the representation corresponding to a back side of a left hand would be encompassed by an imaginary design that comprises (1) a first rectangular region that has a first side, a second side, a third side and a fourth side, (2) second, third, fourth and fifth rectangular regions extending from the first side of the first rectangular region and (3) a sixth rectangular region extending from the second side of the first rectangular region, in which:
a first axis of symmetry of the first rectangular region that is parallel to the second and fourth sides of the first rectangular region extends away from the first side in a first direction, with the second side to the right of the first axis of symmetry and the fourth side to the left of the first axis of symmetry,
respective axes of each of the second, third, fourth and fifth rectangular regions extend away from the first side in respective directions that define angles of not more than 45 degrees (and in some embodiments not more than 20 degrees) from the first direction,
an axis of the sixth rectangular region extends away from the second side, and
the surface area of the imaginary design is substantially equal to (e.g., between 95 percent and 105 percent of) the surface area of the representation corresponding to a back side of a left hand,
   and in some of such embodiments:
(a) the length of the first and third sides is 70 to 120 percent (and in some embodiments, 82 to 93 percent) of the length of the second and fourth sides of the first rectangular region,
(b) for one or more of the second, third, fourth and fifth rectangular regions, two sides are between 2.5 and 5 times as long as the other two sides
   (and in some embodiments, the second rectangular region is closest to the sixth rectangular region, the third rectangular region is farther from the sixth rectangular region than the second rectangular region, the fourth rectangular region is farther from the sixth rectangular region than the third rectangular region, and the fifth rectangular region is farther from the sixth rectangular region than the fourth rectangular region, the lengths of two sides of the second rectangular region are 15 to 35 percent (and in some embodiments, 20 to 30 percent) of the length of the two other sides of the second rectangular region, the lengths of two sides of the third rectangular region are 13 to 33 percent (and in some embodiments, 18 to 28 percent) of the length of the two other sides of the third rectangular region, the lengths of two sides of the fourth rectangular region are 15 to 35 percent (and in some embodiments, 20 to 30 percent) of the length of the two other sides of the fourth rectangular region, and the lengths of two sides of the fifth rectangular region are 13 to 33 percent (and in some embodiments, 18 to 28 percent) of the length of the two other sides of the fifth rectangular region),
(c) two sides of the sixth rectangular region are between 2 and 4 times (in some embodiments, 2.7 to 3.8 times (and in some embodiments, 3.1 to 3.4 times) as long as the other two sides of the sixth rectangular region),
(d) the lengths of the long sides of one or more of the second, third, fourth and fifth rectangular regions are 80 to 120 percent of the lengths of the second and fourth sides of the first rectangular region
   (and in some embodiments, the second rectangular region is closest to the sixth rectangular region, the third rectangular region is farther from the sixth rectangular region than the second rectangular region, the fourth rectangular region is farther from the sixth rectangular region than the third rectangular region, and the fifth rectangular region is farther from the sixth rectangular region than the fourth rectangular region, the lengths of two sides of each of the second rectangular region and the fourth rectangular region are 62 to 82 percent (and in some embodiments 67 to 77 percent) of the lengths of the second and fourth sides of the first rectangular region, the lengths of two sides of the third rectangular region are 67 to 87 percent (and in some embodiments 72 to 82 percent) of the lengths of the second and fourth sides of the first rectangular region, and the lengths of two sides of the fifth rectangular region are 49 to 69 percent (and in some embodiments 54 to 64 percent) of the lengths of the second and fourth sides of the first rectangular region), and/or
(e) the lengths of the long sides of the sixth rectangular region are 30 to 100 percent (and in some embodiments, 49 to 69 percent, and in some embodiments, 54 to 64 percent) of the lengths of the second and fourth sides of the first rectangular region.

In some embodiments in accordance with the present inventive subject matter, the expression “representation of a right hand back side”, as used herein, e.g. in the expression “a representation of a left hand back side and a representation of a right hand back side are on the first surface” means that an image or a structure corresponding to a back side of a right hand is on the first surface (i.e., if the representation of the hand is oriented such that at least one of the fingers is pointing upward, the representation of a thumb would be on the left side of the representation of the hand). In sonic embodiments in accordance with the present inventive subject matter, the expression “representation of a right hand back side” encompasses any representation of a right hand back side that is analogous to (i.e., a mirror image of) any representation a left hand back side as described above.

The expression “representation of a left hand back side is to the left of the representation of a right hand back side” (or analogous or similar expressions), as used herein, means that if the surface on which the representations are provided is oriented such that at least one of the finger regions of the representation of a left hand back side is pointing upward and at least one of the finger regions of the representation of a right hand back side is pointing upward, the representation of the left hand back side will be to the left of the representation of a right hand back side.

A statement that an orientation of the image (or representation) of a left hand back side is substantially the same as the orientation of the image (or representation) of a right hand back side (or an analogous or similar statement) means that if the contact structure on which the images (or representations) is provided is oriented such that at least one of the finger regions of the left hand back side is upward, at least one of the finger regions of the right hand back side will also be upward (or within 30 degrees of vertical), and in some embodiments, such a statement means that respective directions that respective axes of the finger regions of each of the left hand back side and the right hand back side extend from their corresponding back-of-hand region (or first rectangular region) are all within 45 degrees (and in some embodiments within 30 degrees or within 20 degrees) of a first direction.

In some embodiments in accordance with the present inventive subject matter, the expression “representation of a left foot top side”, as used herein, e.g. in the expression “a representation of a left foot top side and a representation of a right foot top side are on the second surface” means that an image or a structure corresponding to a top side of a left foot is on the second surface (i.e., if the representation of the foot is oriented such that at least one of the toes is pointing upward, a representation of a big toe would be on the right side of the representation of the foot). In some embodiments in accordance with the present inventive subject matter, the expression “representation of a left foot top side” encompasses any representation that would be interpreted as representing a left foot (with the top side of the foot facing the viewer) by at least 50 percent of a randomly selected group of people (the group including at least ten people)—for instance, at least 50 percent of a randomly selected group of people, upon being shown the representation(s) and asked to give one answer as to what the representation(s) is (are), would give “a foot” (or “feet”) as their response.

In some embodiments in accordance with the present inventive subject matter, the expression “representation of a left foot top side”, as used herein, e.g. in the expression “a representation of a left foot top side and a representation of a right foot top side are on the second surface” means that an image or a structure corresponding to a top side of a left foot is on the second surface (i.e., if at least one representation of a toe is pointing upward, a representation of a big toe would be to the right of the representations of the other toes). In some embodiments in accordance with the present inventive subject matter, the expression “corresponding to a top side of a left foot” (e.g., as used in the preceding sentence) encompasses any structure that has (1) a top-of-foot region, (2) four toe regions extending from a first side of the top-of-foot region, each toe extending from the top-of-foot region in a direction that is within 25 degrees from a first direction, and (3) a big toe region extending from the first side of the top-of-foot region in a direction that is within 25 degrees from the first direction.

In some embodiments in accordance with the present inventive subject matter, the expression “corresponding to a top side of a left foot”, encompasses only representations that have (1) a top-of-foot region, (2) four toe regions extending from the top-of-foot region, and (3) a big toe region extending from the top-of-foot region, where at least 70 percent (and in some embodiments, at least 80 percent, at least 85 percent or at least 90 percent) of the surface area of the representation corresponding to a top side of a left foot would be encompassed by an imaginary design that comprises (1) a first frustoconical section that has a first side, a second side, a third side and a fourth side, (2) first, second, third, fourth and fifth rectangular regions extending from the first side of the first frustoconical section and (3) a first hemispherical region positioned with its flat edge co-linear with (and co-extensive with) the third side of the first frustoconical section, i.e., the flat edge of the first hemispherical region and the third side of the first frustoconical section constitute the exact same line segment) the third side of the first frustoconical section (i.e., the diameter of the hemispherical region is equal in length to the third side of the first frustoconical section (or the radius of the hemispherical region is one-half the length of the third side of the first frustoconical section), in which:
an axis of symmetry of the first frustoconical section bisects the first and third sides of the first frustoconical section and extends away from the first side of the first frustoconical section in a first direction, the first side of the first frustoconical section being longer than the third side of the first frustoconical section, the second side of the first frustoconical section being to the right of the axis of symmetry of the first frustoconical section and the fourth side of the first frustoconical section to the left of the axis of symmetry of the first frustoconical section,
respective axes of each of the first, second, third, fourth and fifth rectangular regions extend away from the first side in respective directions that define angles of not more than 25 degrees (and in some embodiments not more than 10 degrees) from the first direction,
the surface area of the imaginary design is substantially equal to (e.g., between 95 percent and 105 percent of) the surface area of the representation corresponding to a top side of a left foot,
   and in some of such embodiments:
(a) the length of the first side of the first frustoconical section is 30 to 95 percent (and in some embodiments, 48 to 58 percent) of the length of the second and fourth sides of the first frustoconical section,
(b) the length of the third side of the first frustoconical section is 23 to 74 percent (and in some embodiments, 31 to 51 percent or 36 to 46 percent) of the length of the second and fourth sides of the first frustoconical section,
(c) the length of the third side of the first frustoconical section is 43 to 140 percent (and in some embodiments, 68 to 88 percent or 73 to 83 percent) of the length of the first side of the first frustoconical section,
(d) if the representation of the foot is oriented such that at least one of the toes is pointing upward, the first rectangular region is farthest to the right (i.e., it is a representation of a big toe), the second rectangular region is the closest to the first rectangular region, the third rectangular region is farther from the first rectangular region than the second rectangular region, the fourth rectangular region is farther from the first rectangular region than the third rectangular region, and the fifth rectangular region is farther from the first rectangular region than the fourth rectangular region, and
   the lengths of two sides of the first rectangular region are 50 to 90 percent (and in some embodiments, 60 to 80 percent or 65 to 75 percent) of the lengths of the two other sides of the first rectangular region,
   the lengths of two sides of the second rectangular region are 22 to 72 percent (and in some embodiments, 30 to 50 percent or 35 to 45 percent) of the lengths of the two other sides of the second rectangular region,
   the lengths of two sides of the third rectangular region are 17 to 54 percent (and in some embodiments, 20 to 40 percent or 25 to 35 percent) of the lengths of the two other sides of the third rectangular region,
   the lengths of two sides of the fourth rectangular region are 20 to 64 percent (and in some embodiments, 25 to 45 percent or 30 to 40 percent) of the lengths of the two other sides of the fourth rectangular region,
   the lengths of two sides of the fifth rectangular region are 35 to 115 percent (and in some embodiments, 52 to 73 percent or 57 to 68 percent) of the lengths of the two other sides of the fifth rectangular region,
   the lengths of the two longer sides of one or more of the first rectangular region, the second rectangular region and the third rectangular region are 16 to 53 percent (and in some embodiments, 20 to 40 percent or 25 to 35 percent) of the lengths of the second and fourth sides of the first frustoconical section,
   the lengths of the two longer sides of the fourth rectangular region are 11 to 37 percent (and in some embodiments, 13 to 32 percent or 15 to 25 percent) of the lengths of the second and fourth sides of the first frustoconical section, and/or
   the lengths of the two longer sides of the fifth rectangular region are 6 to 21 percent (and in some embodiments, 8 to 16 percent or 10 to 14 percent) of the lengths of the second and fourth sides of the first frustoconical section,

In some embodiments in accordance with the present inventive subject matter, the expression “representation of a right foot top side”, as used herein, e.g. in the expression “a representation of a left foot top side and a representation of a right foot top side are on the first surface” means that an image or a structure corresponding to a top side of a right foot is on the first surface (i.e., if the representation of the foot is oriented such that at least one of the toes is pointing upward, the representation of a big toe would be to the left side of the representation of the foot). In some embodiments in accordance with the present inventive subject matter, the expression “representation of a right foot top side” encompasses any representation of a right foot top side that is analogous to (i.e., a minor image of) any representation a left foot top side as described above.

The expression “representation of a left foot top side is to the left of the representation of a right foot top side” (or analogous or similar expressions), as used herein, means that if the surface on which the representations are provided is oriented such that at least one of the toe regions of the representation of a left foot top side is pointing upward and at least one of the toe regions of the representation of a right foot top side is pointing upward, the representation of the left foot top side will be to the left of the representation of a right foot top side.

The expression “substantially same size”, as used herein, e.g. in the expression “the image of a left hand back side being substantially the same size as the image of a right hand back side”, means that the dimensions of one of the structures or images that are being characterized as being substantially the same size are each within the range of from 90 percent to 110 percent of the dimensions of the other of the structures or images that are being characterized as being of substantially the same size.

The expression “major surface” as used herein, means a surface that has a surface area that comprises at least 25 percent of the surface area of the entire structure, and in some cases at least 40 percent of the surface area of the entire structure (e.g., each of the top and bottom surfaces of a substantially flat thin substrate having substantially parallel top and bottom surfaces). For example, the expression “the first surface and the second surface being major surfaces of the contact structure”, as used herein, means that the first surface and the second surface of the contact structure each have a surface area that comprises at least 25 percent (and in some embodiments, at least 40 percent) of the entire surface area of the contact structure.

The expression “generally rectangular”, as used herein, means that a rectangular shape can be identified, wherein at least 80% of the points in the item that is being characterized as being substantially rectangular fall within the rectangular shape, and the rectangular shape includes at least 80% of the points in the item. In some situations, the item that is being characterized as being substantially rectangular has somewhat rounded corners.

A statement that an orientation of the image (or representation) of a left foot top side is substantially the same as the orientation of the image (or representation) of a right foot top side (or an analogous or similar statement) means that if the contact structure on which the images (or representations) is provided is oriented such that at least one of the toe regions of the left foot top side is upward, at least one of the toe regions of the right foot top side will also be upward (or within 30 degrees of vertical), and in some embodiments, such a statement means that respective directions that respective axes of the toe regions of each of the left foot top side and the right foot top side extend from their corresponding top-of-foot region (or first frustoconical section) are all within 45 degrees (and in some embodiments within 30 degrees or within 20 degrees) of a first direction.

The expression “axis of substantial symmetry”, as used herein, when referring to a structure (e.g., “axis of substantial symmetry of the first surface”) can refer to a straight line about which the structure is substantially symmetrical (i.e., at least 80 percent (and in some cases at least 85 percent or at least 90 percent) of the surface area of the structure on a first side of the axis maps onto structure on the other side of the axis, and vice-versa). In instances where the structure is not substantially symmetrical about any line, the expression “axis of substantial symmetry” can refer to (1) a line that would pass through a center of gravity of the structure if the structure were of uniform thickness and density, and/or (2) a line about which rotation of the structure would be substantially balanced if the structure were of uniform thickness and density.

Unless otherwise defined, all terms (including technical and scientific terms) used herein have the same meaning as commonly understood by one of ordinary skill in the art to which this inventive subject matter belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

Images of one or more hands and/or one or more feet can be of any suitable color or color combinations (e.g., hands can be one color and feet another color; left hand can be one color, right hand can be another color; left hand and right hand can be of the same colors, arranged in similar ways, as mirror-images, or in different ways, etc.).

As noted above, in some embodiments in accordance with the present inventive subject matter representations (e.g., images and/or structures) of one or more hands and/or one or more feet can be provided on a contact structure. Any such images are functional in that they produce a stimulus to a person on a swing to take an action that is sought (e.g., kicking the contact structure with his or her foot (or feet) or hitting the contact structure with his or her hand (or hands). The functional effects of the representations in accordance with the present inventive subject matter can be quantified by measuring (1) the reliability of kicking and/or hitting (i.e., during what percentage of the total number of swing cycles does the person in the swing contact the contact structure with his or her foot (or feet) or hand (or hands), (2) the average force with which the person in the swing contacts the contact structure, and/or other objective indicia. In other words, the functional nature of the representations on contact structures in accordance with the present inventive subject matter can be demonstrated by comparing such objective indicia with the values for the same objective indicia obtained when a device that lacks the representations (and/or that has other representations) is used (e.g., with the same person on the swing in each case, and with all other factors being substantially identical).

As noted above, in various aspects according to the present inventive subject matter, there is provided a sensory input device that comprises at least one contact structure. The contact structure can be made of any suitable material or materials, a wide variety of which are available to those of skill in the art. In some embodiments in accordance with the present inventive subject matter, the sensory input device can comprise one or more materials that will provide a jarring sensation to a person who contacts it. In some embodiments in accordance with the present inventive subject matter, the contact structure can be resilient, durable, soft to the touch, resistant to bending, and/or non-squishy. In some embodiments in accordance with the present inventive subject matter, the contact structure can comprise wood (e.g., a wood center, for example, wood wrapped with one or more rubber material), steel, rubber (e.g., EPDM granulated rubber), foam, and/or plastic, in any suitable combination or formulation, with or without any of a variety of coatings (e.g., polyurethane, etc.). Persons of skill in the art are very familiar with providing materials or combinations of materials that can be used to make structures that have any of the properties listed above to any suitable degree.

In some embodiments in accordance with the present inventive subject matter, the size and shape of a contact structure can be any desired size and shape. For example, a contact structure can be generally rectangular with rounded corners, with one dimension being about the shoe size (or slightly larger) of the person using the device (e.g., about six inches to about fourteen inches, such as eight inches or ten inches), and with the other dimension being eighteen inches to four feet, e.g., twenty-two inches to three feet long (for example, first and second major surfaces of a sensory input device according to the present inventive subject matter can be, for example, eight inches by twenty-three inches), and with a thickness of about one inch to about two inches, and with the hand (and/or hands) and foot (and/or feet) upright (or substantially upright) with the contact structure oriented with its longer dimension extending generally horizontally.

The contact structure can be of any suitable weight. For example, in some embodiments in accordance with the present inventive subject matter, the contact structure can weigh about one pound to about three pounds, e.g., about two and a half pounds.

As noted above, in some embodiments in accordance with the present inventive subject matter, the sensory input device can comprise at least one handle. A handle (or handles) can be any structure that would assist one in holding the sensory input device in place for a person using it. For example, a handle can comprise an opening extending through the contact structure whereby one can extend his or hand through the opening to grip the contact structure. Alternatively or additionally, a handle can comprise structure that one can grip to hold the contact structure, e.g., a knob, a U-shaped structure, etc.

As noted above, in some aspects of the present inventive subject matter, there is provided a sensory input apparatus comprising a sensory input device corresponding to any of the subject matter described above, and at least one support structure, the sensory input device being attached to the support structure. In such aspects, the support structure can be any suitable structure for holding the sensory input device. A support structure, if included, can hold the sensory input device in any suitable orientation (e.g., such that the hand (or hands) and/or the foot (or feet) are upright), which can be adjustable (automatically and/or manually) to one or more other orientations, if desired, and/or can hold the sensory input device at any suitable height, which can be adjustable (automatically and/or manually) to one or more other heights, if desired, and/or can hold the sensory input device at any suitable location relative to a swing, which can be adjustable (automatically and/or manually) to one or more other locations relative to the swing.

In some embodiments in accordance with the present inventive subject matter, the sensory input device can comprise one or more features that become activated when a person contacts a representation of a hand and/or a representation of a foot. As described above, a representation can be an image and/or a structural feature. A feature that becomes activated can be any suitable feature, e.g., a light (or lights) that illuminates (e.g., a flash that is visible but that turns off quickly enough that, for instance, a person who is swinging might be challenged to make contact with a representation, or with plural representations, on each back and forth swing). Such a feature can be activated by any suitable component or combination of components, e.g., one or more pushbuttons can be positioned on the representation (or on each of one or more representations), and/or one or more touchscreen devices can be positioned on the representation (or on each of one or more representations). Any such components can be selected from a variety of components well known to those of skill in the art.

As described above, the present invention also provides a method comprising positioning a person who has been characterized as having compromised sensory functions (e.g., based on a score in a SIFT (Sensory Integration and Praxis Test)(for example a score of less than 85) and/or based on a Sensory Performance Assessment) on a swing that can swing to a location where the person's hands or feet can contact a sensory input device corresponding to any of the subject matter described above. In such a method, the “positioning a person” can be carried out by the person getting into the swing, by one or more other people, or by both (i.e., one or more people assisting another person getting into the swing). In such a method, the swinging action can be created by the person in the swing (e.g., by pumping his or her legs), by one or more people not in the swing (e.g., by a person gently pushing the person in the swing), automatically by the swing, etc., or by any combination of such forces.

Embodiments in accordance with the present inventive subject matter are described herein in detail in order to provide exact features of representative embodiments that are within the overall scope of the present inventive subject matter. The present inventive subject matter should not be understood to be limited to such detail.

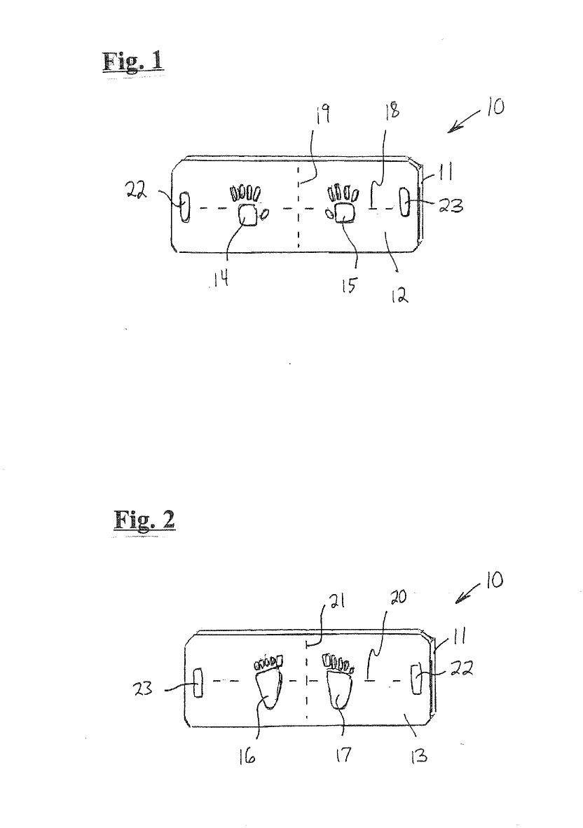

FIGS. 1 and 2 illustrate an embodiment of a sensory input device 10 comprising a contact structure 11 that comprises a first surface 12 (visible in FIG. 1) and a second surface 13 (visible in FIG. 2). As shown in FIG. 1, an image of a left hand back side 14 and an image of a right hand back side 15 are perceptible on the first surface 12. As shown in FIG. 2, an image of a left foot top side 16 and an image of a right foot top side 17 are perceptible on the second surface 13.

As shown in FIGS. 1 and 2, the first surface 12 and the second surface 13 are each major surfaces of the contact structure.

As shown in FIG. 1, the image of a left hand back side 14 is to the left of the image of a right hand back side 15, the image of a left hand back side 14 is substantially the same size as the image of a right hand back side 15, and the orientation of the image of a left hand back side 14 is substantially the same as the orientation of the image of a right hand back side 15.

As shown in FIG. 2, the image of a left foot top side 16 is to the left of the image of a right foot top side 17, the image of a left foot top side 16 is substantially the same size as the image of a right foot top side 17, and the orientation of the image of a left foot top side 16 is substantially the same as the orientation of the image of a right foot top side 17.

As shown in FIG. 1, the first surface 12 has a first axis of substantial symmetry 18 and a second axis of substantial symmetry 19, the first axis of substantial symmetry 18 is longer than the second axis of substantial symmetry 19, the second axis of substantial symmetry is oriented in a first direction, and the orientation of the image of a left hand back side 14 and the orientation of the image of a right hand back side 15 are aligned with the first direction.

As shown in FIG. 2, the second surface 13 has a first axis of substantial symmetry 20 and a second axis of substantial symmetry 21, the first axis of substantial symmetry 20 is longer than the second axis of substantial symmetry 21, the second axis of substantial symmetry 21 is oriented in the first direction, the orientation of the image of a left foot top side and the orientation of the image of a right foot top side are aligned with the first direction.

As shown in FIGS. 1 and 2, the first surface 12 and the second surface 13 are each generally rectangular (with rounded corners).

As shown in FIGS. 1 and 2, the sensory input device comprises a first handle 22 (in the form of an opening extending through the contact structure 11) and a second handle 23 (also in the form of an opening extending through the contact structure 11).

As shown in FIG. 1, the regions of the image of a left hand back side 14 and the image of a right hand back side 15 that represent fingers and thumbs are each generally rectangular with rounded corners, as are the regions of the image of a left foot top side 16 and the image of a right foot top side 17 that represent toes (as shown in FIG. 2).

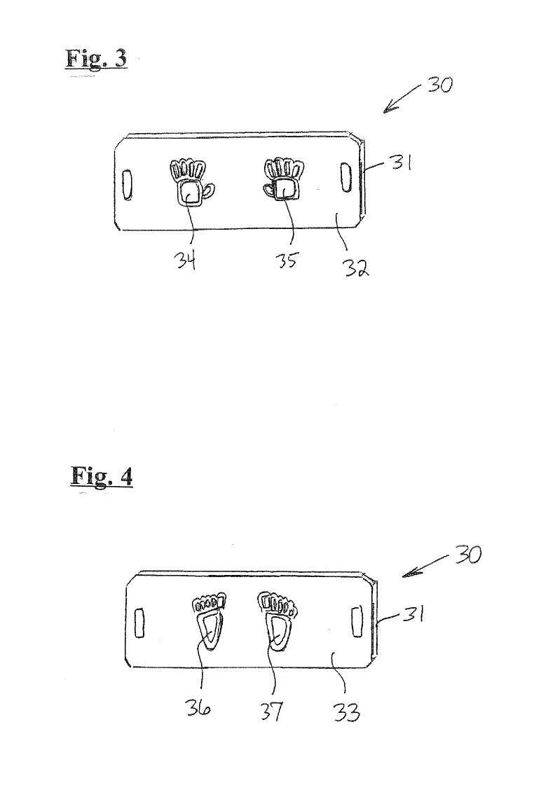

FIGS. 3 and 4 illustrate an embodiment of a sensory input device 30 comprising a contact structure 31 that comprises a first surface 32 (visible in FIG. 3) and a second surface 33 (visible in FIG. 4). As shown in FIG. 3, a representation of a left hand back side 34 and a representation of a right hand back side 35 are perceptible on the first surface 32. As shown in FIG. 4, a representation of a left foot top side 36 and a representation of a right foot top side 37 are perceptible on the second surface 13.

The sensory input device 30 is similar to the sensory input device 10, except that in the sensory input device 30, the representation of a left hand back side 34, the representation of a right hand back side 35, the representation of a left foot top side 36 and the representation of a right foot top side 37 are all structural rather than images (the regions of the representation of a left hand back side 34 and the representation of a right hand back side 35 are all indented in the first surface 32, and the regions of the representation of a left foot top side 36 and the representation of a right foot top side 37 are all indented in the second surface 33). Alternatively, any regions (or portions thereof) could protrude from the first surface 32 or the second surface 33.

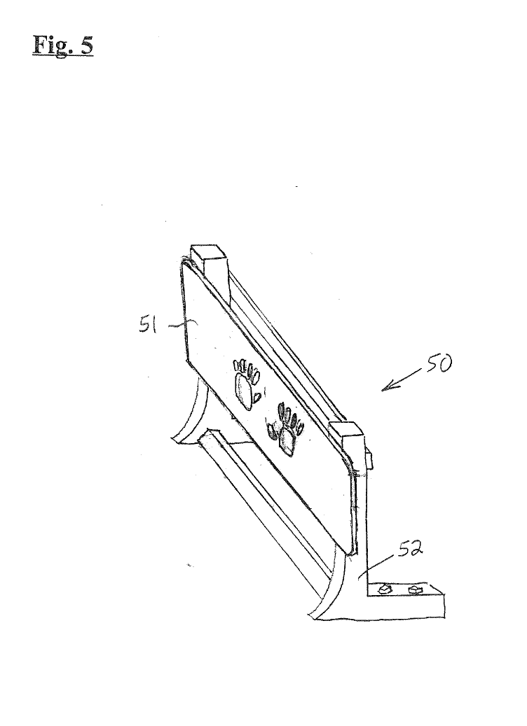

FIG. 5 illustrates an embodiment of a sensory input apparatus 50 that comprises a sensory input device 51 and a support structure 52 to which the sensory input device is attached.

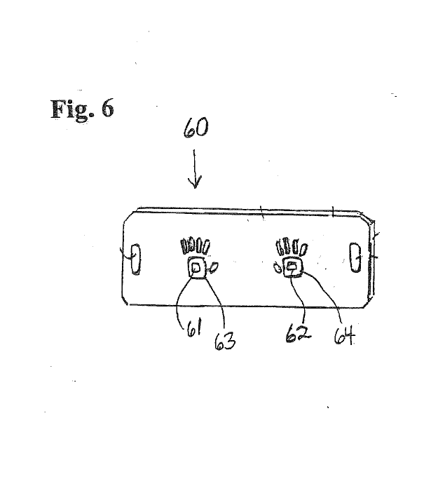

FIG. 6 illustrates an embodiment of a sensory input apparatus 60 that comprises a first pushbutton 61 and a second pushbutton 62 which, when contacted, activate lights 63 and 64, respectively.

Many alterations and modifications may be made by those having ordinary skill in the art, given the benefit of the present disclosure, without departing from the spirit and scope of the inventive subject matter. Therefore, it must be understood that the illustrated embodiments have been set forth only for the purposes of example, and that it should not be taken as limiting the inventive subject matter as defined by the following claims. The following claims are, therefore, to be read to include not only the combination of elements which are literally set forth but all equivalent elements for performing substantially the same function in substantially the same way to obtain substantially the same result. The claims are thus to be understood to include what is specifically illustrated and described above, what is conceptually equivalent, and also what incorporates the essential idea of the inventive subject matter.

Any two or more structural parts of the sensory input devices described herein can be integrated. Any structural part of the sensory input devices described herein can be provided in two or more parts (which may be held together in any known way, e.g., with adhesive, screws, bolts, rivets, staples, etc.).

1. A sensory input device comprising:
at least one contact structure that comprises a first surface and a second surface,
the first surface and the second surface being major surfaces of the contact structure,
an image of a left hand back side and an image of a right hand back side on the first surface,
an image of a left foot op side and an image of a right foot top side on the second surface,
the image of a left hand back side to the left of the image of a right hand back side,
the image of a left hand back side being substantially the same size as the image of a right hand back side,
the image of a left foot top side to the left of the image of a right foot top side,
the image of a left foot top side being substantially the same size as the image of a right foot top side,
an orientation of the image of a left hand back side being substantially the same as an orientation of the image of a right hand back side,
an orientation of the image of a right foot top side being substantially the same as an orientation of the image of a left foot top side.

2. A sensory input device as recited in claim 1, wherein:
the first surface and the second surface each have a first axis of substantial symmetry and a second axis of substantial symmetry, the first axis of substantial symmetry being longer than the second axis of substantial symmetry, the second axis of substantial symmetry being oriented in a first direction,
the orientation of the image of a left hand back side and the orientation of the image of a right hand back side are aligned with the first direction.

3. A sensory input device as recited in claim 2, wherein the first surface and the second surface are each generally rectangular.

4. (canceled)

5. A sensory input device as recited in claim 1, wherein the sensory input device comprises at least one handle.

6. (canceled)

7. A sensory input apparatus comprising:
a sensory input device as recited in claim 1; and
at least one support structure, the sensory input device being attached to the support structure.

8. A sensory input device comprising:
at least one contact structure that comprises a first surface and a second surface,
at least one representation of a hand perceptible on the first surface,
at least one representation of a foot perceptible on the second surface.

9. A sensory input device as recited in claim 8, wherein:
a representation of a left hand back side and a representation of a right hand back side are on the first surface,
the representation of a left hand back side is to the left of the representation of a right hand back side,
the representation of a left hand back side is substantially the same size as the representation of a right hand back side,
a representation of a left foot top side and a representation of a right foot top side are on the second surface,
the representation of a left foot top side is to the left of the representation of a right foot top side,
the representation of a left foot top side is substantially the same size as the representation of a right foot top side.

10. A sensory input device as recited in claim 9, wherein the representations are images.

11. A sensory input device as recited in claim 9, wherein the representations are structural.

12-13. (canceled)

14. A sensory input device as recited in claim 8, wherein:
the first surface and the second surface are each generally rectangular, with a first dimension in the range of from about six inches to about fourteen inches and a second dimension in the range of from about eighteen inches to about four feet, and
the first surface and the second surface are substantially parallel and spaced from each other by from about one inch to about two inches.

15. A sensory input device as recited in claim 8, wherein the sensory input device comprises at least one handle.

16. (canceled)

17. A sensory input device as recited in claim 8, wherein:
the first surface and the second surface are each generally rectangular, with a first dimension in the range of from about six inches to about fourteen inches and a second dimension in the range of from about eighteen inches to about four feet, and
the first surface and the second surface are substantially parallel and spaced from each other by from about one inch to about two inches,
an image of a left hand back side and an image of a right hand back side are on the first surface,
the image of a left hand back side is to the left of the image of a right hand back side,
an orientation of the image of a left hand back side is substantially the same as an orientation of the image of a right hand back side and is aligned with the first dimension, and
an orientation of the image of a right foot top side is substantially the same as an orientation of the image of a left foot top side and is aligned with the first dimension.

18. A sensory input apparatus comprising:
a sensory input device as recited in claim 8; and
at least one support structure, the sensory input device being attached to the support structure.

19. A sensory input device comprising:
at least one contact structure that comprises a first surface and a second surface,
the first surface and the second surface being major surfaces of the contact structure,
the first surface and the second surface each having a first axis of substantial symmetry and a second axis of substantial symmetry, the first axis of substantial symmetry being longer than the second axis of substantial symmetry, the second axis of substantial symmetry being oriented in a first direction,
an image of a left hand back side and an image of a right hand back side on the first surface,
the image of a left hand back side to the left of the image of a right hand back side,
the image of a left hand back side being substantially the same size as the image of a right hand back side,
the orientation of the image of a left hand back side being substantially the same as the orientation of the image of a right hand back side,
the orientation of the image of a left hand back side and the orientation of the image of a right hand back side being aligned with the first direction.

20. A sensory input device as recited in claim 19, wherein the first surface and the second surface are each generally rectangular.

21. A sensory input device as recited in claim 19, wherein:
the contact structure has a dimension along the first axis of substantial symmetry that is in the range of from about eighteen inches to about four feet, and
the contact structure has a dimension along the second axis of substantial symmetry that is in the range of from about six inches to about fourteen inches.

22. A sensory input device as recited in claim 19, wherein the sensory input device comprises at least one handle.

23. A sensory input device as recited in claim 19, wherein:
the sensory input device comprises a first handle and a second handle,
the first handle comprises a first hole extending from the first surface to the second surface, and
the second handle comprises a second hole extending from the first surface to the second surface.

24. A sensory input apparatus comprising:
a sensory input device as recited in claim 19; and
at least one support structure, the sensory input device being attached to the support structure,

25-30. (canceled)

31. A method comprising:
positioning a person a person who has been characterized as having compromised sensory functions on a swing that can swing to a location where the person's hands or feet can contact a sensory input device as recited in claim 1.
